(19) United States
(12) Patent Application Publication
(10) Pub. No.: US 2015/0033157 A1
(43) Pub. Date: Jan. 29, 2015

(54) 3D DISPLAYING APPARATUS AND THE METHOD THEREOF

(71) Applicant: MEDIATEK INC., Hsin-Chu (TW)

(72) Inventors: Te-Hao Chang, Taipei City (TW); Chao-Chung Cheng, Tainan City (TW); Yu-Lin Chang, Taipei (TW); Yu-Pao Tsai, Kaohsiung City (TW); Ying-Jui Chen, Hsinchu County (TW)

(73) Assignee: MEDIATEK INC., Hsin-Chu (TW)

(21) Appl. No.: 14/177,198

(22) Filed: Feb. 10, 2014

Related U.S. Application Data
(60) Provisional application No. 61/858,587, filed on Jul. 25, 2013.

(51) Int. Cl. G06F 3/0481; G06T 19/20

(52) U.S. Cl. CPC G06F 3/04815; G06T 19/20
USPC 715/763

(57) ABSTRACT

A 3D displaying method, comprising: acquiring distance information map from at least one image; receiving control information from a user input device; modifying the distance information map according to the control information to generate modified distance information map; generating an interactive 3D image according to the modified distance information map; and displaying the interactive 3D image.

### CROSS REFERENCE TO RELATED APPLICATIONS

This application claims the benefit of U.S. Provisional Application No. 61/858,587, filed on Jul. 25, 2013, the contents of which are incorporated herein by reference.

### BACKGROUND

A three-dimensional (3D) display method is a popular technology in recent years. Many methods can be applied to generate a 3D image. One of the methods is converting 2D images to 3D images. Depth map is needed while converting 2D images to 3D images, which is a grey scale image indicating distances between objects in the images and a reference plane (ex. the plane on which a camera is provided for capturing images). Via referring to the depth map, disparity for human eyes can be estimated and simulated while converting 2D images to 3D images, such that 3D images can be accordingly generated.

However, in the related art, a 3D image can only be watched by a user but cannot present interacting effect with the user.

### SUMMARY

One embodiment of the present application is to provide a 3D displaying method thereby the user can interact with the 3D image.

Another embodiment of the present application is to provide a 3D displaying apparatus thereby the user can interact with the 3D image.

One embodiment of the present application discloses a 3D displaying method, comprising: acquiring distance information map from at least one image; receiving control information from a user input device; modifying the distance information map according to the control information to generate modified distance information map; generating an interactive 3D image according to the modified distance information map; and displaying the interactive 3D image.

Another embodiment of the present application discloses a 3D displaying apparatus, comprising: a user input device; a distance information map acquiring/modifying module, for acquiring distance information map from at least one image, for receiving control information from the user input device, and for modifying the distance information map according to the control information to generate modified distance information map; a 3D image generating module, for generating an interactive 3D image according to the modified distance information map; and a display, for displaying the interactive 3D image.

In view of above-mentioned embodiments, the 3D image can be displayed corresponding to the control command of a user. By this way, a user can interact with a 3D image such that the application of 3D images can be further extended.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow chart illustrating a 3D displaying method according to one embodiment of the present application.

FIG. 2 is a schematic diagram illustrating modifying the distance information map locally and modifying the distance information map globally.

FIG. 3 is a schematic diagram describing the 3D displaying method illustrated in FIG. 1 for more detail.

FIG. 4 and FIG. 5 are schematic diagrams illustrating the operation for locally modifying the distance information map according to one example of the present application.

FIG. 6 and FIG. 7 are schematic diagrams illustrating the operation for globally modifying the distance information map according to one example of the present application.

FIG. 8 is a block diagram illustrating a 3D displaying apparatus according to one embodiment of the present application.

### DETAILED DESCRIPTION

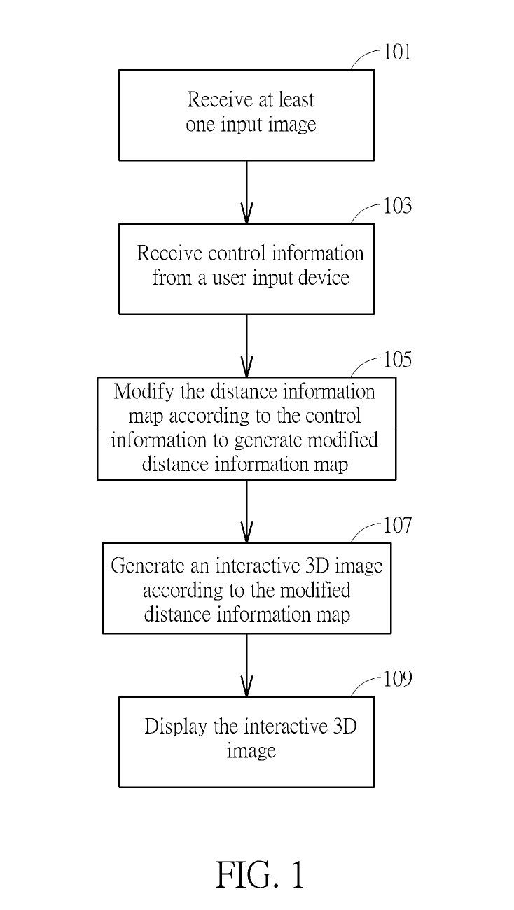

FIG. 1 is a flow chart illustrating a 3D displaying method according to one embodiment of the present application. In the following embodiment, it is assumed that the method is applied to a mobile phone with a touch screen, but it is not limited. Other user input devices beside the touch screen can also be applied to the mobile phone, such as the position or object on the screen indicated by eye/pupil tracking. Also, other devices besides the mobile phone utilizing any kind of user input device also fall in the scope of the present application.

As shown in FIG. 1, the 3D displaying method comprises:

Step 101

Acquire distance information map from at least one image.

The distance information map, for example, can comprise the above-mentioned depth map. Alternatively, the distance information map can comprise other type of distance information map such as disparity map. The disparity map can be transformed from the depth map, thus can indicate distance information as well. In the following embodiments, the depth map is held as an example for explanation.

Step 103

Receive control information from a user input device.

Step 105

Modify the distance information map according to the control information to generate modified distance information map.

Step 107

Generate an interactive 3D image according to the modified distance information map.

Step 109

Display the interactive 3D image.

For the step 101, the distance information map can be acquired from at least one 2D image or at least one 3D image, which will be described for more detail later.

For the step 103, the user input device can be any device that can receive a control operation from a user. For example, a touch screen, a mouse, a touch pen, an eye/face/head tracking device, a gyro, a G sensor, or a bio signal generating device can be applied as the user input device. Therefore, the control information can correspondingly comprise at least one of the following information: touch information, track information, movement information, tilting information, and bio signal information. The touch information indicates the information generated by an object touching a touch sensing device (ex. a finger or a touch pen, touches a touch screen). The touch information can comprise the location for the object, or a touch period that the object touches the touch sensing device. The track information indicates a track that the object performs to the touch sensing device, or a track that performed by any other user input device (ex. a mouse, a tracking ball, an eye/face/head tracking device). The movement information indicates the movement for the mobile phone, which can be generated by a movement sensing device such as a gyro. The tilting information indicates the angle that the mobile phone tilts, which can be sensed by a tilting sensing device such as a G-sensor. The bio signal information is determined by a bio signal generating device, which is connected to human body to sense body signal such as brainwaves.

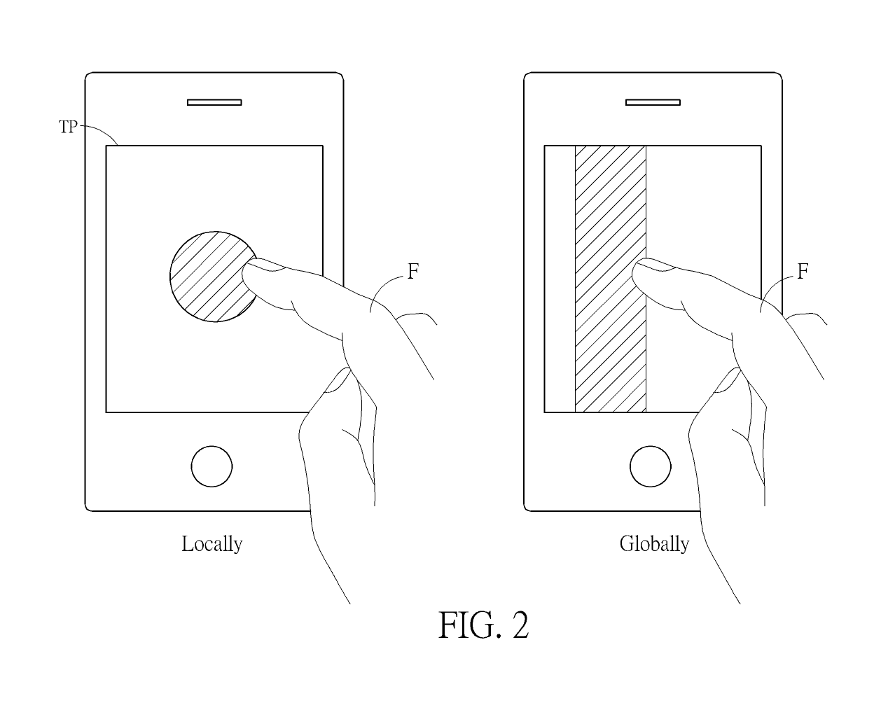

For the step 105, the distance information map can be locally modified or globally modified according to the control information. FIG. 2 is a schematic diagram illustrating modifying the distance information map locally and modifying the distance information map globally. In FIG. 2, the region marked by oblique lines indicates that the distance information map for the region is modified. As shown in FIG. 2, locally modifying the distance information map indicates only distance information map of a small region close to a point of the touch screen TP is modified, wherein the point is touched by the object (finger F in this example) or the point is activated. Oppositely, globally modifying the distance information map indicates distance information map which is not close to a point that the object touches the touch screen TP or the point is activated can be modified as well. Also, in one embodiment, the step 105 can further comprise at least one segmentation operation to modify the distance information map. The segmentation operation is a skill that cut the images into a plurality of parts based on the objects in the images, such that the depth can be modified more precisely.

For the step 107, the generation for the interactive 3D image is different corresponding to how the distance information map is acquired, which will be described later.

For the step 109, the interactive 3D image can be a multi-view 3D image or a stereo 3D image. The multi-view 3D image is a 3D image that can be simultaneously watched by more than one person. The stereo 3D image is a 3D image that can be watched by a single person.

Also, in one embodiment, the distance information map in the steps 101, 105, 107 is multi layer distance information map (multi layer depth map or multi layer disparity map).

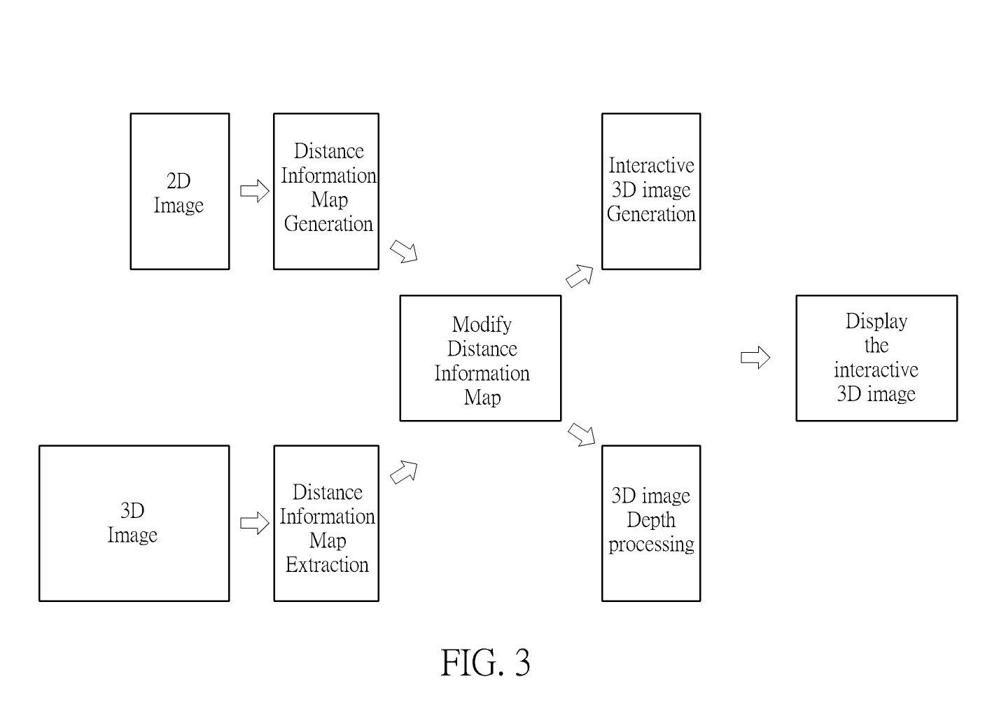

FIG. 3 is a schematic diagram describing the 3D displaying method illustrated in FIG. 1 for more detail. AS shown in FIG. 3, the distance information map can be acquired from at least one 2D image. Or, the distance information map can be acquired via extracting distance information map from at least one original 3D image. After the distance information map is acquired, modify the distance information map. After modifying the distance information map, an interactive 3D image is generated. If the distance information map is acquired from at least one 2D image, a new 3D image is generated as the interactive 3D image according to the modified distance information map. Besides, if the distance information map is acquired via extracting the original 3D image, the original 3D image is processed according to the modified distance information map to generate the interactive 3D image. The operations in FIG. 3 can be implemented by many conventional manners. For example, depth cue, Z-buffer, graphic layer information can be applied to generate distance information map from at least one 2D image. DIBR (Depth-Image Based Rendering) and GPU rendering can be utilized to generate 3D images from 2D images. Additionally, the operation of extracting distance information map from 3D images can be implemented by stereo matching from at least two views, or the distance information map can be extracted from original source (ex. at least one 2D image plus distance information map based on the 2D image). The operation of processing 3D image depth can be implemented by auto convergence, depth adjustment, DIBR or GPU rendering.

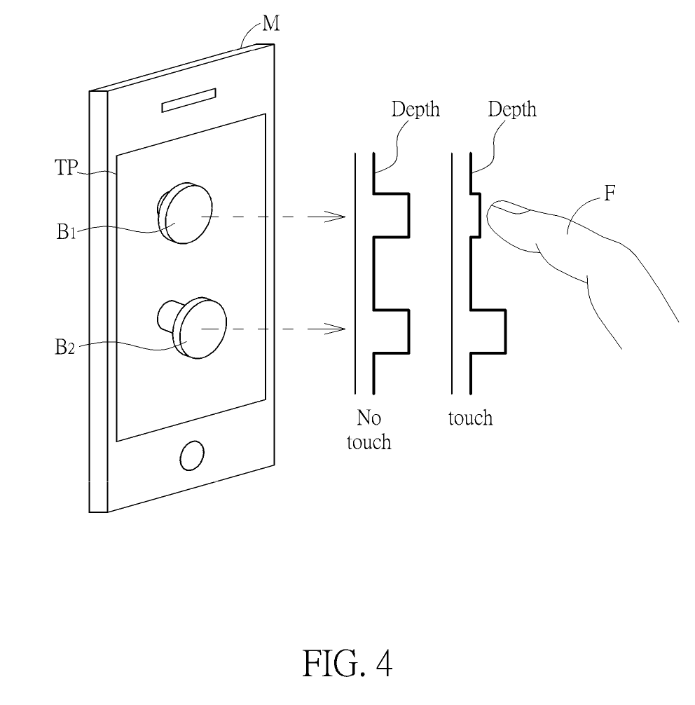

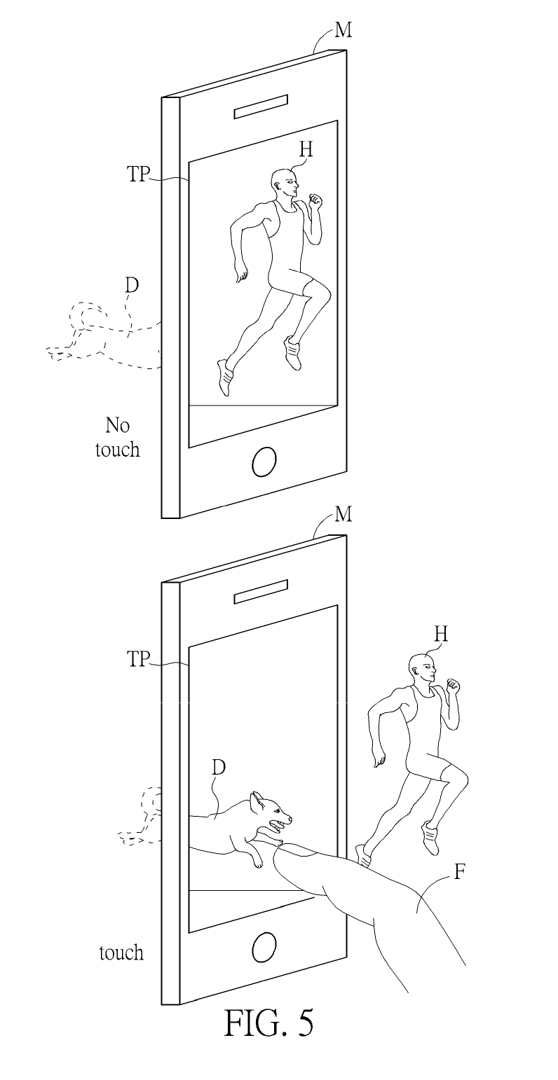

FIG. 4 and FIG. 5 are schematic diagrams illustrating the operation for locally modifying the distance information map according to one example of the present application. Please refer to FIG. 4, the mobile phone M has a touch screen TP displaying two 3D image buttons B₁, B₂. The 3D image buttons B₁, B₂ has the same depth if the touch screen TP is not touched. If a user utilizes a finger F to touch the location of the touch screen TP where the 3D image button B₁ is provided, the depth for the 3D image button B₁ is changed and the depth of the 3D image button B₂ remains the same. By this way, the presentation for the 3D image buttons B₁ is changed since it is processed according to the modified distance information map (i.e. an interactive 3D image is generated), as illustrated in FIG. 1 and FIG. 3. Therefore, a situation that a real button is pressed can be simulated, such that the user can interact with the 3D image. FIG. 4 is an embodiment for locally modifying the distance information map, wherein only the 3D image is changed of the regions near the point that are touched by the finger F.

Please refer to FIG. 5, which illustrates another embodiment for locally modifying distance information map. In the embodiment shown in FIG. 5, the 3D image comprises a human 3D image H and a dog 3D image D. If the user does not touch the touch screen TP, only the human 3D image H looks running appears in front of the touch screen TP. If the user uses a finger F to touch the touch screen TP, the human 3D image H runs more far from the touch screen TP and a dog 3D image D running after the human 3D image H appears (i.e. an interactive 3D image is generated). By this way, the user can feel that a dog vividly runs after a human, interacting with the touch of the user. FIG. 5 is also an embodiment for locally modifying the distance information map, wherein only the 3D image is changed of the regions near the point that are touched by the finger F.

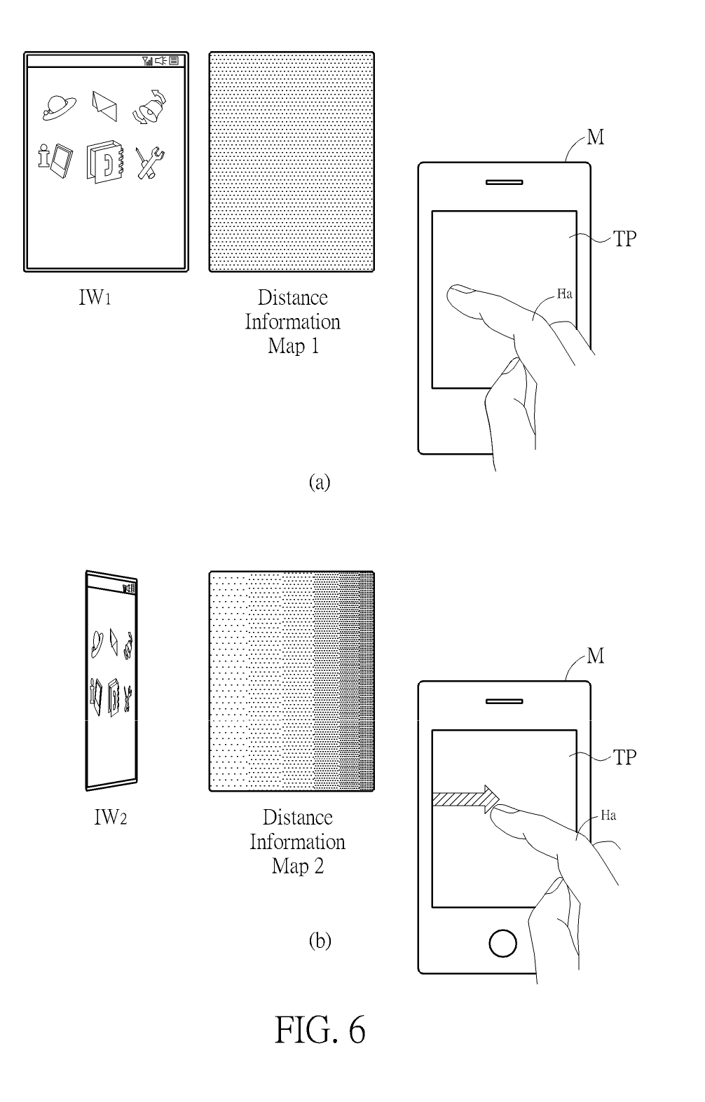

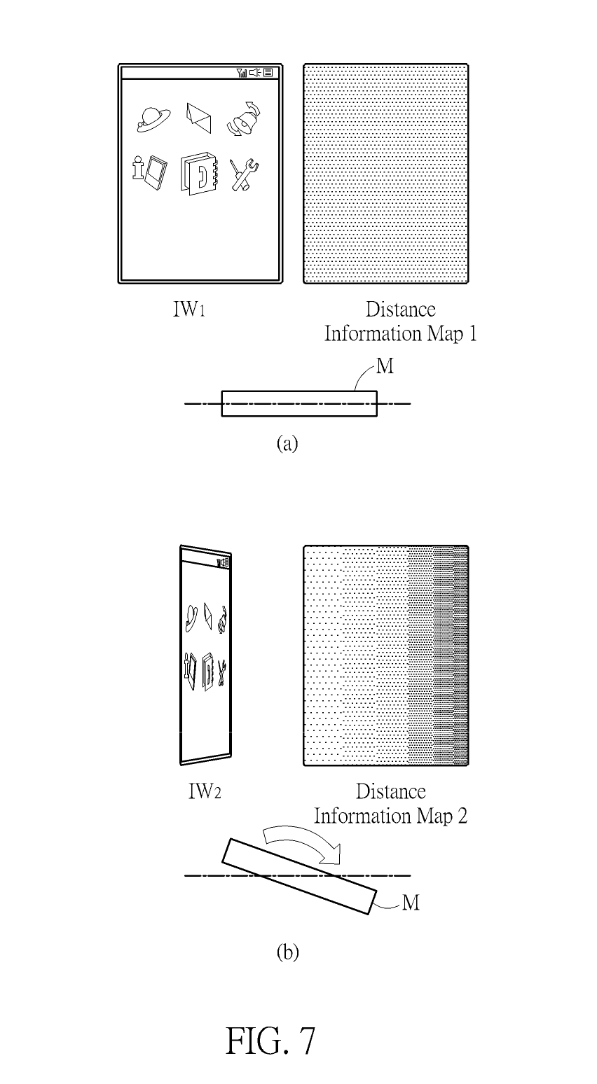

FIG. 6 and FIG. 7 are schematic diagrams illustrating the operation for globally modifying the distance information map according to one example of the present application. FIG. 6 comprises two sub diagrams FIG. 6(a) and FIG. 6(b). As shown in FIG. 6(a), the touch screen TP displays a user interface 3D image IW₁ (i.e. an original 3D image) having distance information map 1 if the user does not touch the touch screen TP or keeps the finger at a fixed location. If the user moves the touch operation on the touch screen TP to form a track, as shown in FIG. 6(b), the touch screen TP displays the user interface 3D image IW₂ having distance information map 2 with gradient depth from left side to right side for example (i.e. an interactive 3D image is generated). By this way, it looks like the user interface interacts with the movement of user's finger to move.

FIG. 7 is an embodiment utilizing a G-sensor, which also comprises two sub diagrams FIG. 7(a) and FIG. 7(b). In FIG. 7(a), the mobile phone M is not tilted and the touch screen TP displays the user interface 3D image IW₁ (i.e. an original 3D image) having the distance information map 1. In FIG. 7 (b), the mobile phone M is tilted such that a G-sensor in the mobile phone M determines control information to modify distance information map. By this way, the touch screen TP displays the user interface 3D image IW₂ (i.e. an interactive 3D image is generated) having the distance information map 2 with gradient depth from left side to right side for example. The embodiments in FIG. 6 and FIG. 7 are embodiments for globally modifying the distance information map, since the distance information map of the regions not close to the point that is touched or activated is also modified.

Please note the claim scope of the present application is not limited to above-mentioned embodiments in FIG. 4-FIG. 6. For example, the above 3D images can comprise at least one of the following 3D images: a photo 3D image, a video 3D image, a gaming 3D image (i.e. the image generated by a game program) and a user interface 3D image. The present application can modify the distance information map according to control information from any electronic device, and determine any type of 3D image according to the modified distance information map.

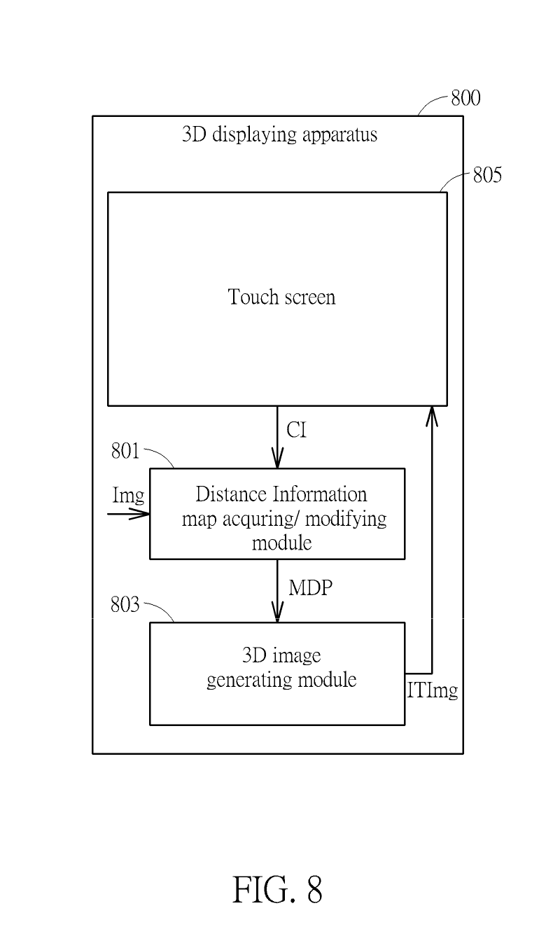

FIG. 8 is a block diagram illustrating a 3D displaying apparatus according to one embodiment of the present application. As shown in FIG. 8, the 3D displaying apparatus 800 comprises a distance information map acquiring/modifying module 801, a 3D image generating module 803, a user input device and a display. Please note the user input device, which determines the control information CI, and the display are comprised in a touch screen 805 in this embodiment. However, the user input device and the display can be independent devices, such as a mouse/a display, a G-sensor/a display in other embodiment. The distance information map acquiring/modifying module 801 acquires distance information map from at least one image Img, receives control information CI from the user input device, and modifies the distance information map according to the control information CI to generate modified distance information map (MDP). The image Img can come from an outer source such as a network or from a computer connected to the 3D displaying apparatus 800, but also can come from an inner source such as a storage device in the 3D displaying apparatus 800. The 3D image generating module 803 generates an interactive 3D image ITImg according to the modified distance information map MDP. The display displays the interactive 3D image.

Other detail operation for the 3D displaying apparatus 800 can be acquired based on above-mentioned embodiments, thus are omitted for brevity here.

In view of above-mentioned embodiments, the 3D image can be displayed corresponding to the control command of a user. By this way, a user can interact with a 3D image such that the application of 3D images can be further extended.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A 3D displaying method, comprising:
acquiring distance information map from at least one image;
receiving control information from a user input device;
modifying the distance information map according to the control information to generate modified distance information map;
generating an interactive 3D image according to the modified distance information map; and
displaying the interactive 3D image.

2. The 3D displaying method of claim 1, wherein the step of acquiring distance information map from at least one image acquires the distance information map from at least one 2D image, and the step of generating an interactive 3D image according to the modified distance information map comprises converting the 2D images to the interactive 3D image according to the modified distance information map.

3. The 3D displaying method of claim 1, wherein the step of acquiring distance information map from at least one image extracts the distance information map from at least one original 3D image, and the step of generating an interactive 3D image according to the modified distance information map comprises processing the original 3D image to generate the interactive 3D image according to the modified distance information map.

4. The 3D displaying method of claim 1, wherein the 3D image is a multi view 3D image or a stereo 3D image.

5. The 3D displaying method of claim 1, wherein the step of modifying the distance information map according to the control information to generate modified distance information map comprises: locally modifying the distance information map according to the control information.

6. The 3D displaying method of claim 1, wherein the step of modifying the distance information map according to the control information to generate modified distance information map comprises: globally modifying the distance information map according to the control information.

7. The 3D displaying method of claim 1, wherein the control information comprises at least one of following information: touch information, track information, movement information, tilting information and bio signal information.

8. The 3D displaying method of claim 1, wherein the distance information map is multi layer distance information map.

9. The 3D displaying method of claim 1, wherein the step of modifying the distance information map according to the control information to generate modified distance information map further comprises:
performing segmentation operation to modify the distance information map.

10. The 3D displaying method of claim 1, wherein the interactive 3D image comprises at least one of following images: a photo 3D image, a video 3D image, a gaming 3D image and a user interface 3D image.

11. A 3D displaying apparatus, comprising:
a user input device, for determining control information;
a distance information map acquiring/modifying module, for acquiring distance information map from at least one image, for receiving the control information from the user input device, and for modifying the distance information map according to the control information to generate modified distance information map;
a 3D image generating module, for generating an interactive 3D image according to the modified distance information map; and
a display, for displaying the interactive 3D image.

12. The 3D displaying apparatus of claim 11, wherein the distance information map acquiring/modifying module from at least one 2D image, and the 3D image generating module coverts the 2D images to the interactive 3D image according to the modified distance information map.

13. The 3D displaying apparatus of claim 11, wherein the distance information map acquiring/modifying module extracts the distance information map from at least one original 3D image, and the step of generating an interactive 3D image according to the 3D image generating module processes the original 3D image to generate the interactive 3D image according to the modified distance information map.

14. The 3D displaying apparatus of claim 11, wherein the 3D image is a multi view 3D image or a stereo 3D image.

15. The 3D displaying apparatus of claim 11, wherein the distance information map acquiring/modifying module locally modifies the distance information map according to the control information.

16. The 3D displaying apparatus of claim 11, wherein the distance information map acquiring/modifying module globally modifies the distance information map according to the control information.

17. The 3D displaying apparatus of claim 11, wherein the control information comprises at least one of following information: touch information, track information, movement information, tilting information and bio signal information.

18. The 3D displaying apparatus of claim 11, wherein the distance information map is multi layer distance information map.

19. The 3D displaying apparatus of claim 11, wherein the distance information map acquiring/modifying module performs segmentation operation to modify the distance information map).

20. The 3D displaying apparatus of claim 11, wherein the interactive 3D image comprises at least one of following images: a photo 3D image, a video 3D image, a gaming 3D image and a user interface 3D image.

21. The 3D displaying apparatus of claim 11, wherein the user input device is incorporated into the display.
